(19) United States
(12) Patent Application Publication
(10) Pub. No.: US 2015/0314439 A1
(43) Pub. Date: Nov. 5, 2015

(54) END EFFECTOR CONTROLLING METHOD

(71) Applicant: PRECISION MACHINERY RESEARCH & DEVELOPMENT CENTER, Taichung (TW)

(72) Inventors: PEI-JUI WANG, HSINCHU CITY (TW); CHIEN-PIN CHEN, TAOYUAN COUNTY (TW)

(73) Assignee: PRECISION MACHINERY RESEARCH & DEVELOPMENT CENTER, Taichung (TW)

(21) Appl. No.: 14/268,104

(22) Filed: May 2, 2014

(51) Int. Cl. B25J 9/16; B25J 15/06

(52) U.S. Cl. CPC B25J 9/1612; B25J 15/0616; Y10S 901/40

(57) ABSTRACT

An end effector controlling method includes the steps of obtaining the 3D physical information of an object, finding an appropriate sucking position by a vector programming method, generating a control command to control the sucking position of an end effector. The vector programming method includes the steps of creating a virtual platform and creating a virtual object on the virtual platform from the obtained 3D physical information, obtaining reference planes from each reference axis, computing a curve of surface interactions of each reference plane and the virtual object separately, and searching a sucking position on each curve according to a reachable range of a finger. of the end effector.

### BACKGROUND OF THE INVENTION

1. Field of the Invention

The present invention relates to an end effector controlling method, and more particularly to the end effector controlling method that determines a sucking point of an object.

2. Description of the Related Art

As the labor cost keeps increasing in recent years, the demand for factory automation becomes increasingly higher, and the mission of a robot is no longer limited to the access and simple assembling of fixed components in production lines anymore, but also needs to satisfy the production requirements for a variety of productions of a small quantity and various assembling shaped components, so that an end effector with higher degree of freedom and a corresponding end effector controlling method becomes increasingly more important. At present, conventional end effector control algorithms with a high degree of freedom are available, but it is still difficult to find an appropriate sucking method from a database due to the special curved appearance of the object, and the conventional method simply provide manual tutorials, thus taking much time and efforts, and these conventional methods are not suitable for the production lines that manufacture a variety of products of a small quantity. Therefore, it is necessary to develop a smart control algorithm that is appropriate for an end effector with a high degree of freedom to meet the industrial requirements.

In view of the aforementioned problems, it is a main subject for related manufactures to overcome the aforementioned problems of the conventional end effector controlling methods.

### SUMMARY OF THE INVENTION

Therefore, it is a primary objective of the present invention to overcome the problems of the prior art by providing an end effector controlling method that uses several method to locate a sucking position of an object and determine the best sucking position in order to suck an object successfully.

To achieve the aforementioned objective, the present invention provides an end effector controlling method executed by software and applied to an effector having a base and at least two fingers coupled thereon each by a pivot shaft, each finger having at least two degrees of freedom for motion with a suction device installed at an terminal end thereof. The controlling method comprises the steps of: obtaining 3D physical information of an object; finding an appropriate sucking position by a vector programming method; and generating a control command to control the end effector to suck an object according to the appropriate sucking position. Wherein, the vector programming method further comprises the steps of: creating a virtual platform, and creating a virtual object on the virtual platform by the obtained 3D physical information of the object; creating a virtual end effector corresponsive to the end effector and disposed at an appropriate distance above the virtual object, wherein each pivot shaft of the virtual effector corresponding to the pivot shafts of the end effector is defined as a reference axis; obtaining a reference plane including the reference axis from each corresponding reference axis; computing a curve of surface interactions of each reference plane and the virtual object; and searching a sucking position on each curve according to a reachable range of a finger of the virtual end effector, wherein the finger of the virtual end effector shall be able to approach the sucking position in a normal vector direction of the curve.

The vector programming method further comprises the step of: setting a reference point on the virtual object. wherein the position of the reference point is projectable onto an area enclosed by the reference axes, and the reference point is a center or mass or a centroid, and the appropriate distance falls within a finger reachable range of the end effector.

The vector programming method further comprises the step of obtaining a second reference plane including the reference axis from a neighborhood of the reference plane if the appropriate sucking position is not found on the curve; computing a second curve of surface interactions of the second reference plane and the virtual object; and searching a sucking position on the second curve according to the vector programming method.

In addition, the controlling method further comprises a typical programming method and a tutorial programming method. The typical programming method comprises the steps of: analyzing the 3D physical information of the object and comparing the 3D physical information of the object with a simple geometric shaped model built in the software; confirming the shape of the surface of the object is similar to the simple geometric shaped model built in the software; and computing the typical sucking position with respect to the simple geometric shaped model built in the software and comparing the 3D physical information of the object to find a sucking position situated on a surface of the object. The tutorial programming method comprises the steps of: manually and directly controlling the end effector to move near the object; manually and directly controlling the finger of the end effector to touch an appropriate position on a surface of the object; confirming that the finger of the end effector is capable of sucking the object at the appropriate position; and recording the appropriate position for suction by the finger.

Further, the controlling method comprises the following steps:

(a) Obtain 3D physical information of an object.

(b) Find an appropriate sucking position by the typical programming method.

(c) Use the vector programming method to find the appropriate sucking position, if the appropriate sucking position cannot be found by the typical programming method.

(d) Use the tutorial programming method to find the appropriate sucking position, if the appropriate sucking position cannot be found by the vector programming method.

(e) Generate a control command to control the end effector to suck the object according to the appropriate sucking position.

After finding the appropriate sucking position, the controlling method further comprises the steps of: computing a normal vector of the sucking position by software;

computing a preparing position disposed outwardly from the sucking position with the normal vector; computing a working position of the end effector and the posture of the finger of the end effector to suck the object to generate a control command; and executing the control command to drive the end effector to suck the object.

### BRIEF DESCRIPTION OF THE DRAWINGS

FIG. 1 is a flow chart of the present invention;

FIG. 2 is a flow chart of a typical programming method of the present invention;

FIG. 3 is a flow chart of a vector programming method of the present invention;

FIG. 4 is a flow chart of a tutorial programming method of the present invention;

FIG. 5 is a flow chart of a controlling method of the present invention after a sucking position is found; and

FIG. 6 is a schematic view of a using status of an end effector of the present invention.

### DETAILED DESCRIPTION OF THE PREFERRED EMBODIMENTS

The technical content of the present invention will become apparent with the detailed description of preferred embodiments and the illustration of related drawings as follows.

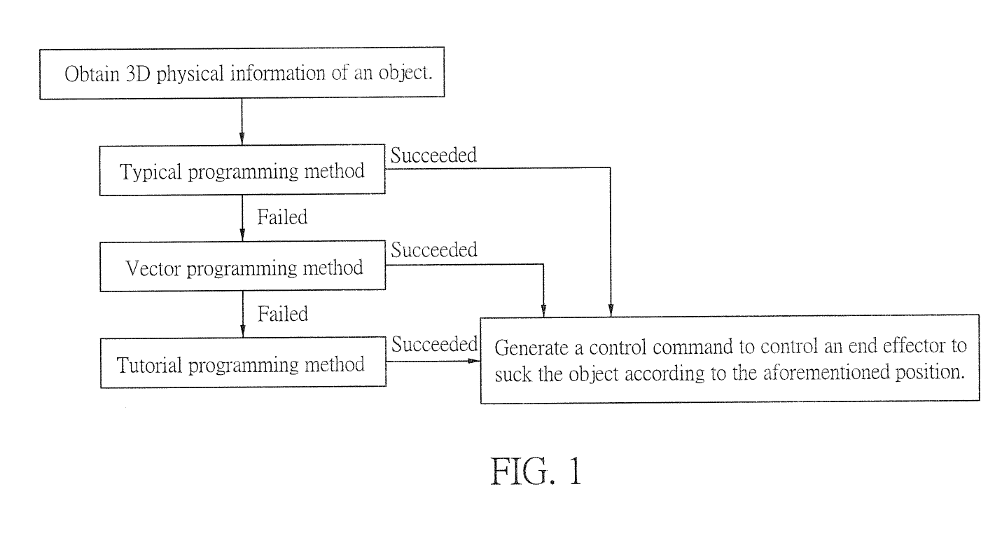

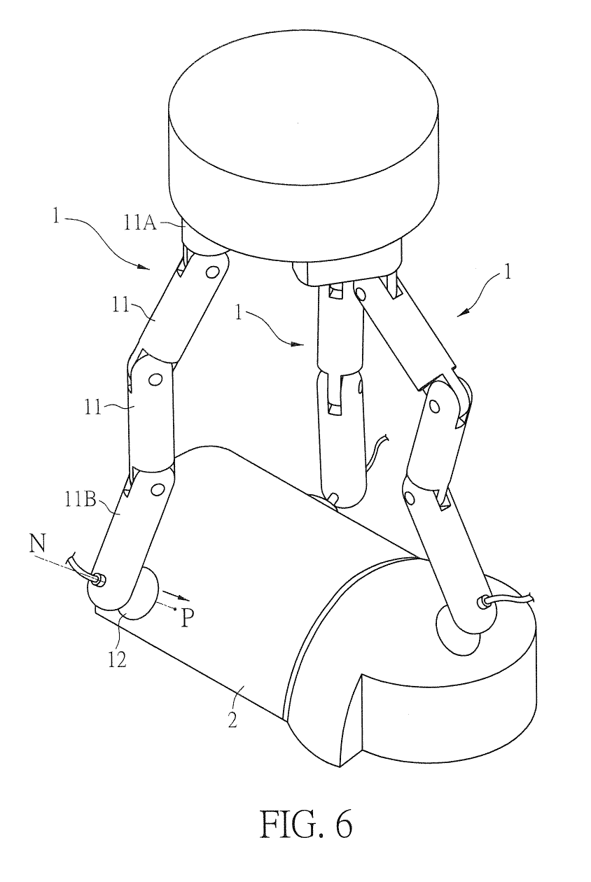

The end effector controlling method of the present invention is executed by software and applied to an end effector having at least two fingers, and each finger has at least two degrees of freedom for motion with a suction device installed at the terminal end thereof. With reference to FIG. 6 for a preferred embodiment of the end effector, the end effector has three fingers 1, and each finger 1 has four degrees of freedom for motion, wherein each finger 1 has three knuckles 11, and each knuckle 11 is pivotally swung with respect to an adjacent knuckle thereof, and a top knuckle 11A is pivotally coupled to a base 13 by a pivot shaft 14 to drive others knuckles to pivotally turn altogether. Through the four degrees of freedom of each finger, a suction device 12 installed at an end knuckle 11B may suck an object 2 from a direction N at a position P on a surface of the object 2. The controlling method of the present invention as shown in FIG. 1 comprises the following steps:

(a) Obtain 3D physical information of an object.

(b) Find an appropriate sucking position by a typical programming method.

(c) Use a vector programming method to find the appropriate sucking position, if the appropriate sucking position cannot be found by the typical programming method.

(d) Use a tutorial programming method to find the appropriate sucking position, if the appropriate sucking position cannot be found by the vector programming method.

(e) Generate a control command to control the end effector to suck the object according to the appropriate sucking position.

In the controlling method, the graphic or model files of the desired sucking object is inputted into the software or through other methods such as a 3D laser scan or a 3D vision to obtain 3D physical information of an object first, and then a typical programming method and a vector programming method are sequentially provided to search an appropriate sucking position of the object. If the appropriate sucking position cannot be found by these methods, then a tutorial programming method is finally used. These programming methods are described as follows.

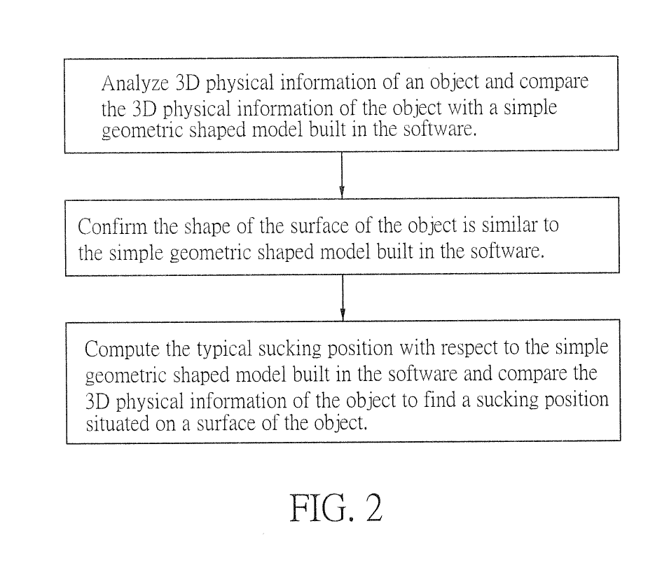

With reference to FIG. 2 for the typical programming method, this method comprises the steps of: analyzing the 3D physical information of the object and comparing the 3D physical information of the object with a simple geometric shaped model built in the software; confirming the shape of the surface of the object is similar to the simple geometric shaped model built in the software; and computing the typical sucking position with respect to the simple geometric shaped model built in the software and comparing the 3D physical information of the object to find a sucking position situated on a surface of the object.

In short, the typical programming method compares the desired sucking object with each simple geometric shaped model such as a sphere, a tablet or a cuboid built in the software, and analyzes which simple geometric shaped model is similar to the object in order to adopt an algorithm of such simple geometric shaped model built in the software and compares the 3D physical information of the object to compute the sucking position. For example, each built-in simple geometric shaped model is zoomed in/out to generate models with a shape inscribed and circumscribed by the model created in the 3D physical information of the object and calculate the volume difference of the two. Through the threshold analysis, the three sets of data are analyzed to determine whether or not the object is similar to one of the built-in simple geometric shaped models. Since the typical programming method has built in an algorithm with corresponding geometric shapes in the software, the built in algorithm can be used to program the sucking position quickly as long as the shape of the target object is confirmed to be similar to a specific geometric shape.

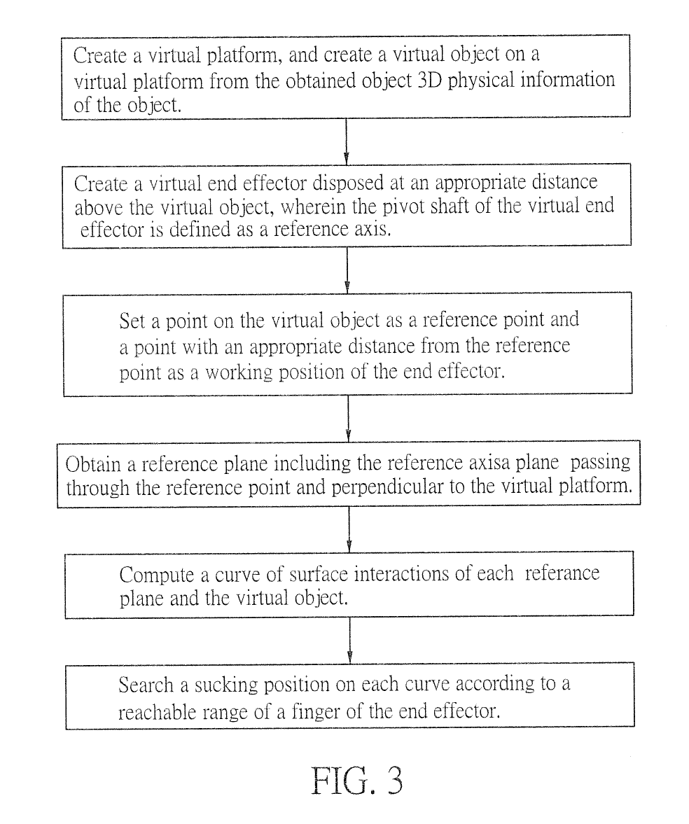

If the desired sucking object is not similar to any simple geometric shaped model built in the software, then the vector programming method will be used to search the sucking position. The vector programming method as shown in FIG. 3 comprises the steps of: creating a virtual platform, and creating a virtual object on the virtual platform by the obtained 3D physical information of the object; creating a virtual end effector corresponsive to the end effector and disposed at an appropriate distance above the virtual object, wherein each pivot shaft of the virtual effector corresponding to the pivot shafts of the end effector is defined as a reference axis; obtaining a reference plane including the reference axis from each corresponding reference axis; computing a curve of surface interactions of each reference plane and the virtual object; and searching a sucking position on each curve according to a reachable range of a finger of the virtual end effector, wherein the finger of the virtual end effector shall be able to approach the sucking position in a normal vector direction of the curve.

In this programming method, the position of the virtual end effector is selected by setting a reference point on the virtual object and selecting a position with an appropriate distance from the reference point, wherein the position of the reference point is projectable onto an area enclosed by the reference axes. In this preferred embodiment, the reference point is selected from the center of mass or the centroid of the virtual object that can be obtained by analysis through the software, and the appropriate distance is determined within a finger reachable range of the end effector. Therefore, the virtual end effector uses this position as a basis for programming the sucking position. Next, a reference plane including the reference axis corresponding to each reference axis is obtained, and these reference planes and the surface of the virtual object are intersected to form a plurality of curves. Through software computation. a sucking position is searched from the farthest position to the nearest position within a reachable position of the finger of the virtual end effector on each curve. More specifically, the curve is formed by connecting a plurality of points, and the normal vector of each point is computed by software. A certain point is the appropriate sucking position if the finger of the virtual end effector can be able to approach it in the normal vector direction thereof.

If the appropriate sucking position cannot be found on the curve. then a second reference plane including the reference axis is obtained from a neighborhood of the reference plane. In other words, the second reference plane is produced by rotating the aforementioned reference plane along the reference axis by a certain angle, and a second curve of surface interactions of the second reference plane and the virtual object is computed, and the sucking position is searched from the second curve according to this method. In this preferred embodiment, the second reference plane is deviated by 1 degree from the previous reference plane. Repeat the same procedure if the appropriate sucking position is still not found.

The sucking positions programmed by the vector programming method have the advantages of being distributed uniformly at positions with respect to the reference point of the object under the conditions of the sucking characteristics and the finger reachable range of the end effector, and each sucking position is far away from the of the reference point of the object. Therefore, the end effector can program the sucking position according to the method to suck the object securely.

However, if both typical programming method and vector programming method fail to find the appropriate sucking position, the tutorial programming method will be used as the final tool for finding the sucking position.

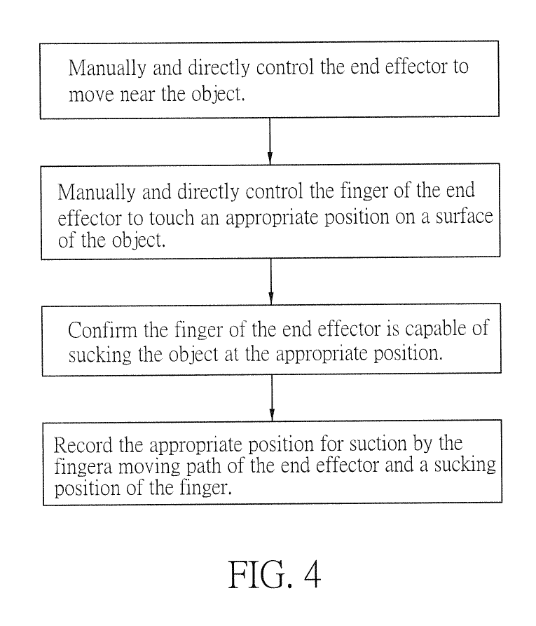

The tutorial programming method as shown in FIG. 4 comprises the steps of: manually and directly controlling the end effector to move near the object; manually and directly controlling the finger of the end effector to touch an appropriate position on a surface of the object; confirming that the finger of the end effector is capable of sucking the object at the appropriate position; and recording the appropriate position for suction by the finger.

The tutorial programming method is finally applied to find the appropriate sucking position if the previous two automatically executed programming methods both fail. In this method. an operator manually and directly controls the end effector to grab the object, and the grabbing position is determined according to the experience and intuition of the operator. After the manually grabbing position is determined to grab the object successfully, the software records the sucking position on the surface of the object, so that the software can control the end effector to repeat the same process automatically for the next use.

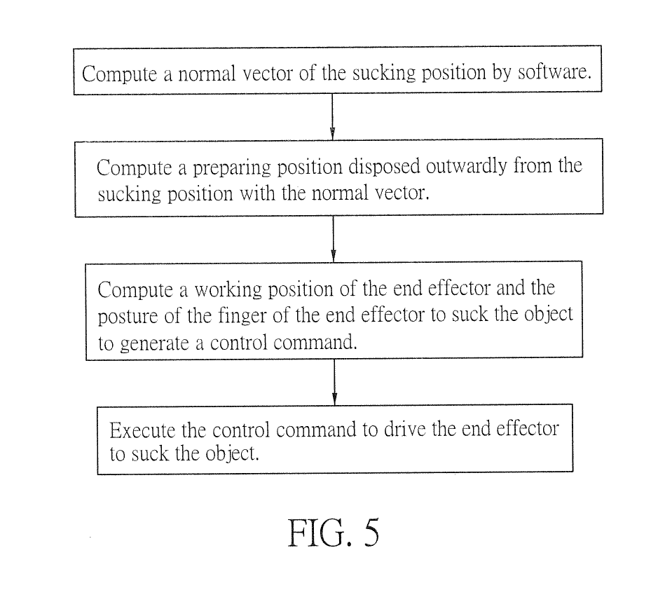

In summation, the controlling method of the present invention sequentially uses the typical programming method, vector programming method and tutorial programming method to find an appropriate sucking position on an object and generates a control command through software to control the end effector. In FIG. 5, after the sucking position is found, the normal vector of the sucking position is computed by software, and then a preparing position situated outwardly from the sucking position is computed. In the meantime, a working position of the end effector is computed, wherein the working position is the position where the base of the end effector is situated, and the preparing position is the position of the finger of the end effector before starting sucking the object. Then the posture of the finger of the end effector sucking the object is computed to generate a control command, and the control command is executed to control each knuckle of the finger of the end effector to produce movements to suck the object.

What is claimed is:

1. An end effector controlling method, executed by software, and applied to an effector having a base and at least two fingers coupled thereon each by a pivot shaft, each finger having at least two degrees of freedom for motion with a suction device installed at an terminal end thereof, and the controlling method comprising the steps of:
obtaining 3D physical information of an object;
finding an appropriate sucking position by a vector programming method; and
generating a control command to control the end effector to suck an object according to the appropriate sucking position;
wherein the vector programming method further comprises the steps of:
creating a virtual platform, and creating a virtual object on a virtual platform from the obtained 3D physical information of the object;
creating a virtual end effector corresponsive to the end effector and disposed at an appropriate distance above the virtual object, wherein each pivot shaft of the virtual end effector corresponding to the pivot shafts of the end effector is defined as a reference axis;
obtaining a reference plane including the reference axis from each reference axis;
computing a curve of surface interactions of each reference plane and the virtual object;
searching a sucking position on each curve according to a reachable range of a finger of the virtual end effector. wherein the finger of the virtual end effector shall be able to approach the sucking position in a normal vector direction of the curve.

2. The end effector controlling method of claim 1, wherein the vector programming method further comprises the step of setting a point on the virtual object as a reference point and building the virtual end effector at a position with an appropriate distance from the reference point, and the position of the reference point is projectable within an area enclosed by the reference axes.

3. The end effector controlling method of claim 2, wherein the reference point described in the vector programming method is a center of mass or a centroid.

4. The end effector controlling method of claim 1, wherein the appropriate distance described in the vector programming method falls within a finger reachable range of the end effector.

5. The end effector controlling method of claim 1, wherein the vector programming method further comprises the steps of:
obtaining a second reference plane including the reference axis from a neighborhood of the reference plane if the appropriate sucking position is not found on the curve;
computing a second curve of surface interactions of the second reference plane and the virtual object; and
searching a sucking position one second reference curve according to the vector programming method.

6. The end effector controlling method of claim 1, further comprising a typical programming method, and the typical programming method comprising the steps of:
analyzing the 3D physical information of the object and comparing the 3D physical information of the object with a simple geometric shaped model built in the software;
confirming the shape of the surface of the object is similar to the simple geometric shaped model built in the software; and
computing the typical sucking position with respect to the simple geometric shaped model built in the software and comparing the 3D physical information of the object to find a sucking position situated on a surface of the object.

7. The end effector controlling method of claim 6, further comprising a tutorial programming method, and the tutorial programming method comprising the steps of:
manually and directly controlling the end effector to move near the object;
manually and directly controlling the finger of the end effector to touch an appropriate position on a surface of the object;
confirming that the finger of the end effector is capable of sucking the object at the appropriate position; and
recording the appropriate position for suction by the finger.

8. The end effector controlling method of claim 7. comprising the steps of:
(a) obtaining 3D physical information of an object;
(b) finding an appropriate sucking position by the typical programming method;
(c) using the vector programming method to find the appropriate sucking position, if the appropriate sucking position cannot be found by the typical programming method;
(d) using the tutorial programming method to find the appropriate sucking position, if the appropriate sucking position cannot be found by the vector programming method; and
(e) generating a control command to control the end effector to suck an object according to the appropriate sucking position.

9. The end effector controlling method of claim 1, further comprising a tutorial programming method, and the tutorial programming method comprising the steps of:
manually and directly controlling the end effector to move near the object;
manually and directly controlling the finger of the end effector to touch an appropriate position on a surface of the object;
confirming that the finger of the end effector is capable of sucking the object at the appropriate position; and
recording the appropriate position for suction by the finger.

10. The end effector controlling method of claim 1, wherein after the appropriate sucking position is found, the controlling method further comprises the steps of:
computing a normal vector of the sucking position by software;
computing a preparing position disposed outwardly from the sucking position with the normal vector;
computing a working position of the end effector and the posture of the finger of the end effector to suck the object to generate a control command; and
executing the control command to drive the end effector to suck the object.
